(19) United States
(12) Patent Application Publication
(10) Pub. No.: US 2022/0379456 A1
(43) Pub. Date: Dec. 1, 2022

(54) ANTI-OVERFLOW HAMMER AND HANDLE FIXING STRCUTURE

(71) Applicant: LU KANG HAND TOOLS INDUSTRIAL CO., LTD., CHANGHUA HSIEN (TW)

(72) Inventor: Chih-Yuan SU, CHANGHUA HSIEN (TW)

(21) Appl. No.: 17/332,882

(22) Filed: May 27, 2021

(51) Int. Cl. B25G 3/34; B25D 1/04; B25G 1/01

(52) U.S. Cl. CPC B25G 3/34; B25D 1/04; B25G 1/01

(57) ABSTRACT

An anti-overflow hammer and handle fixing structure includes a hammer body and a handle body. The hammer body has a flared slot, and the handle body has a fitting fixed head. After the flared slot of the hammer body is sheathed on the fitting fixed head of the handle body, an adhesive is filled up into the flared slot to improve the stability of combining the hammer body with the handle body and prevent any extra adhesive residue from overflowing to improve the assembly convenience and the structural assembly stability to achieve excellent structural stability and assembly convenience.

### FIELD OF THE INVENTION

The present invention relates to an anti-overflow hammer and handle fixing structure, and in particular to the structure applied to prevent an adhesive from overflowing from a joint edge and to fix a hammer with a handle stably.

### BACKGROUND OF THE INVENTION

With reference to FIG. 8 for a conventional hammer and handle fixing structure, a hammer module 30 is formed by a handle 31 and a plurality of hammer parts, and both sides of the handle 31 have a recess 310, and the middle of the recess 310 has an accommodating groove 311, and each of the hammer parts 32 has a combining slope 320, and the combining slopes 320 of the plurality of hammer parts 32 and the recesses 310 and the accommodating grooves 311 on both sides of the handle 31 are filled with an adhesive for their adhesion and combination. Although the plurality of hammer parts 32 can be combined with the handle 31, the stability of the combination is poor and there is an overflow issue of the adhesive. Obviously, the conventional hammer and handle require improvements.

### SUMMARY OF THE INVENTION

To overcome the poor stability of combination and the overflow issue of the conventional hammer and handle, the present invention provides an anti-overflow hammer and a handle fixing structure in accordance with the invention.

Therefore, it is a primary objective of the present invention to provide an anti-overflow hammer and handle fixing structure comprising a hammer body and a handle body, and the hammer body has a hammer part and a claw part disposed on both sides of the hammer body respectively. The hammer body has a flared slot penetrating from a bottom side to a top side, and the flared slot has a first opening and a second opening, and the first opening has a first fit section extending inwardly and the second opening has a second fit section relative to the first fit section extending from the opposite side of the first opening to the second opening. The first fit section has an inner peripheral wall substantially in a planar configuration and the second fit section has an inner peripheral wall substantially in a slope configuration. The first opening has an opening width A smaller than the opening width B of the second opening. The handle body has a handle part and a fitting fixed head, and the middle section and the upper section of the handle part are substantially in a concave arc configuration and a lower section substantially in a convex arc configuration. The handle part has an anti-slip shock absorber sheathed on an outer side of the handle part, and the anti-slip shock absorber has a first-section sleeve area and a second-section sleeve area, and the second-section sleeve area, and a front side of the second-section sleeve area has an anti-slip grip section, and the anti-slip grip section has a plurality of groove lines spaced with one another. The fitting fixed head has a first fit portion and a second fit portion, and the second fit portion is protruded from the top of the first fit portion, and the top side of the first fit portion opposite relative to both sides of the second fit portion has a serrated block, and the first fit portion has a concave section and a spaced helical serrated section. The concave section of the first fit portion of the fitting fixed head of the handle body has a width C smaller than the width D of the helical serrated end portion width D of the spaced helical serrated section to form an adhesive receiving space. Edges on both sides of the second fit portion have a plurality of adhesive receiving notches spaced from one another, and the flared slot of the hammer body is sheathed on the fitting fixed head of the handle bod, and the first fit section and the second fit section of the flared slot are configured to be relative to the first fit portion and the second fit portion of the fitting fixed head respectively, and the serrated block of the fitting fixed head abuts against an inner wall of the first fit section.

In a preferred embodiment, the fitting fixed head of the handle body has a threaded fixing groove formed at the top side of the first fit portion, and the second fit portion is substantially in a cube-like strip shape, and the cube-like strip shaped second fit portion is passed and accommodated into the threaded fixing groove of the first fit portion. The overall structure and assembly are simple and easy, and the assembled structure has an excellent combining stability to increase the multiple practicality of the present invention.

In a preferred embodiment, the spaced helical serrated section and the serrated block of the first fit portion have a plurality of teeth, each in the shape of an acute angle, a round angle or a trapezium angle, so that the spaced helical serrated section and the serrated block are in a point, line or surface contact with the first fit section to improve the variability of the structural use of the present invention.

In a preferred embodiment, both sides of the first fit section of the flared slot of the hammer body have two positioning latch grooves formed thereon respectively, and the serrated block of the first fit portion of the fitting fixed head is positioned and latched to the positioning latch groove to improve the variability of the structural use of the present invention.

The first fit section and second fit section of the flared slot of the hammer body abutted and latched by the first fit portion and the second fit portion of the handle body respectively to improve the combining stability, and the adhesive is filled into the second opening on the top side of the flared slot, so that the adhesive can be filled up into the internal space of the second opening of the flared slot and permeated into the gap of the first fit section and the second fit section relative to the first fit portion and the second fit portion, and the residue of extra adhesive is guided into the position of the tooth gaps of the serrated block of the first fit portion, the spaced helical serrated section, the concave section, and the adhesive receiving notch of the second fit portion, so that the adhesive can be used for adhering and fixing the hammer body with the handle body and preventing the extra adhesive residue from overflowing after the hammer body and the handle body are combined, so as to improve the assembly convenience and stability, and achieve high structural stability and assembly convenience.

### BRIEF DESCRIPTION OF THE DRAWINGS

FIG. 1 shows a three-dimensional schematic view and its partial blowup state of an anti-overflow hammer and handle fixing structure in accordance with the invention;

FIG. 2 shows a three-dimensional exploded view and its partial blowup state of an anti-overflow hammer and handle fixing structure in accordance with the present invention;

FIG. 3 shows a cross-sectional side view and its partial blowup state of an anti-overflow hammer and handle fixing structure in accordance with the present invention;

FIG. 4 is a cross-sectional side view of an anti-overflow hammer and handle fixing structure in accordance with the present invention, showing the operation of filling an adhesive.

FIG. 5 is a schematic view showing a spaced helical serrated section and a serrated block of a first fit portion of a fitting fixed head of a handle body of an anti-overflow hammer and handle fixing structure in accordance with a first embodiment of the present invention, whose teeth are substantially in the shape of a round angle;

FIG. 6 is a schematic view showing a spaced helical serrated section and a serrated block of a first fit portion of a fitting fixed head of a handle body of an anti-overflow hammer and handle fixing structure in accordance with a second embodiment of the present invention, whose teeth are substantially in the shape of a trapezium angle;

FIG. 7 is a schematic view showing a spaced helical serrated section and a serrated block of a first fit portion of a fitting fixed head of a handle body of an anti-overflow hammer and handle fixing structure in accordance with a third embodiment of the present invention, whose teeth are substantially in the shape of a round angle;

FIG. 7 is a schematic view of an anti-overflow hammer and handle fixing structure in accordance with the third embodiment of the present invention, showing that both sides of a first fit section of a flared slot of a hammer body have latch groove lines which are latched with a serrated block of a first fit portion of a fitting fixed head of a handle body;

FIG. 8 shows a conventional hammer and handle fixing structure in comparison with the anti-overflow hammer and handle fixing structure of the present invention.

### DESCRIPTION OF THE PREFERRED EMBODIMENTS

The aforementioned and other objectives and advantages of this disclosure will become clearer in light of the following detailed description of an illustrative embodiment of this invention described in connection with the drawings.

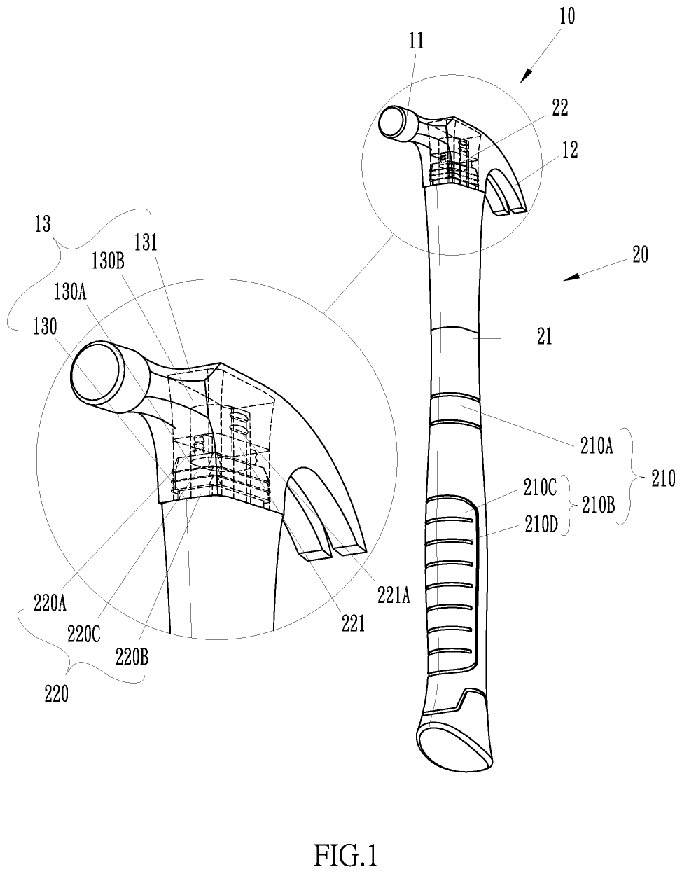

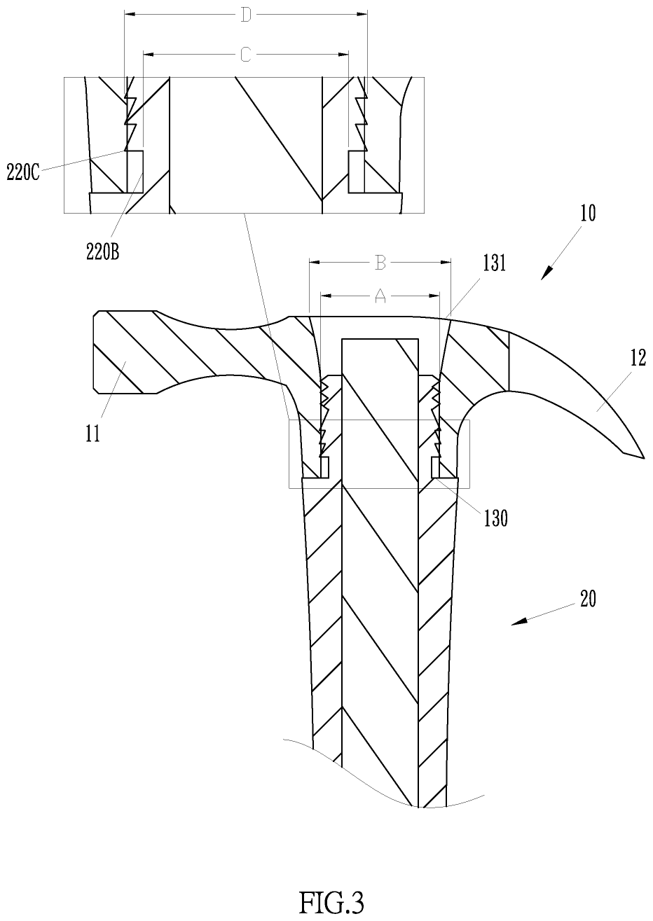

With reference to FIGS. 1 to 3 for the three-dimensional schematic view and its partial blowup state, the three-dimensional exploded view and its partial blowup state, and the cross-sectional side view and its partial blowup state of an anti-overflow hammer and handle fixing structure in accordance with the present invention respectively, the anti-overflow hammer and handle fixing structure comprises:

a hammer body 10, having a hammer part 11 and a claw part 12 disposed on both sides of the hammer body 10 respectively, a flared slot 13 penetrating from a bottom side to a top side and having a first opening 130 and a second opening 131, a first fit section 130A extending inwardly from the first opening 130, and a second fit section 130B relative to the first fit section 130A and the opposite side of the first opening 130 extending to the second opening 131, wherein the first fit section 130A has an inner peripheral wall substantially in a planar configuration, and the second fit section 130B has an inner peripheral inner wall substantially in a slope configuration, and the first opening 130 has an opening width A smaller than the opening width B of the second opening 131; and

a handle body 20, having a handle part 21 and a fitting fixed head 22, and the handle part 21 having a middle section and an upper section substantially in a concave arc shape, and a lower section substantially in a convex arc shape, and an anti-slip shock absorber 210 sheathed on an outer side of the handle part 21, and the anti-slip shock absorber 210 having a first-section sleeve area 210A and a second-section sleeve area 210B, and a front side of the second-section sleeve area 210B having an anti-slip grip section 210C, and the anti-slip grip section 210C having a plurality of groove lines 210D spaced from one another, and the fitting fixed head 22 having a first fit portion 220 and a second fit portion 221, and the second fit portion 221 being protruded from the top of the first fit portion 220, and the top side of the first fit portion 220 relative to both sides of the second fit portion 221 having a serrated block 220A, and the first fit portion 220 having a concave section 220B and a spaced helical serrated section 220C, wherein the concave section 220B has a width C smaller than the width D of the helical serrated end portion of the spaced helical serrated section 220C to form an adhesive receiving space, and edges on both sides of the second fit portion 221 having a plurality of adhesive receiving notches 221A spaced from one another, and the flared slot 13 of the hammer body 10 being sheathed on the fitting fixed head 22, and the first fit section 130A and the second fit section 130B of the flared slot 13 being configured to be relative to the first fit portion 220 and the second fit portion 221 of the fitting fixed head 22 respectively, and the serrated block 220A of the fitting fixed head 22 abutting against an inner wall of the first fit section 130A.

With the aforementioned technical characteristics, the anti-overflow hammer and handle fixing structure of the present invention is formed.

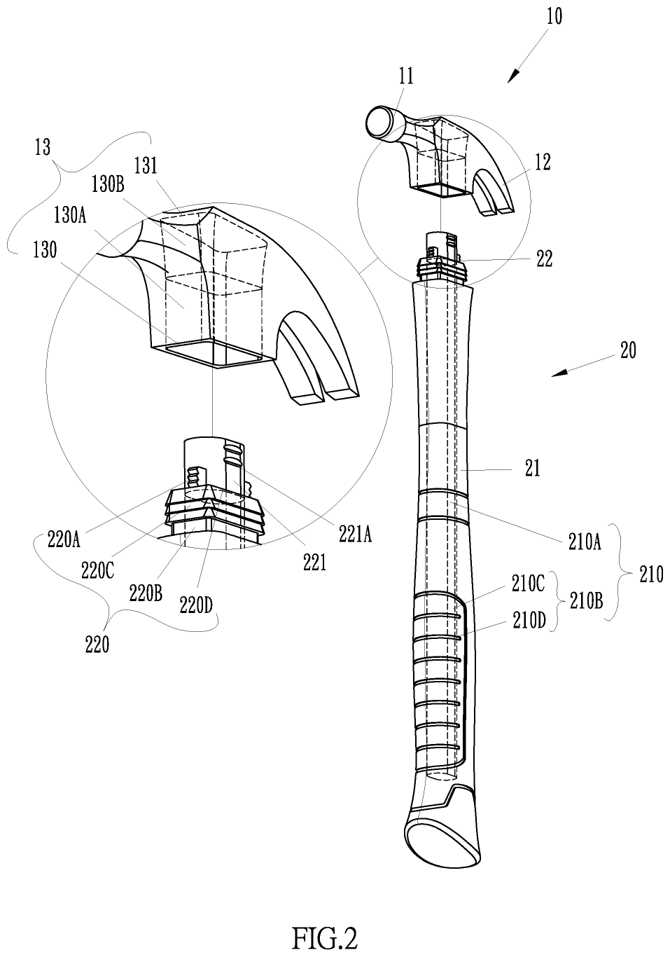

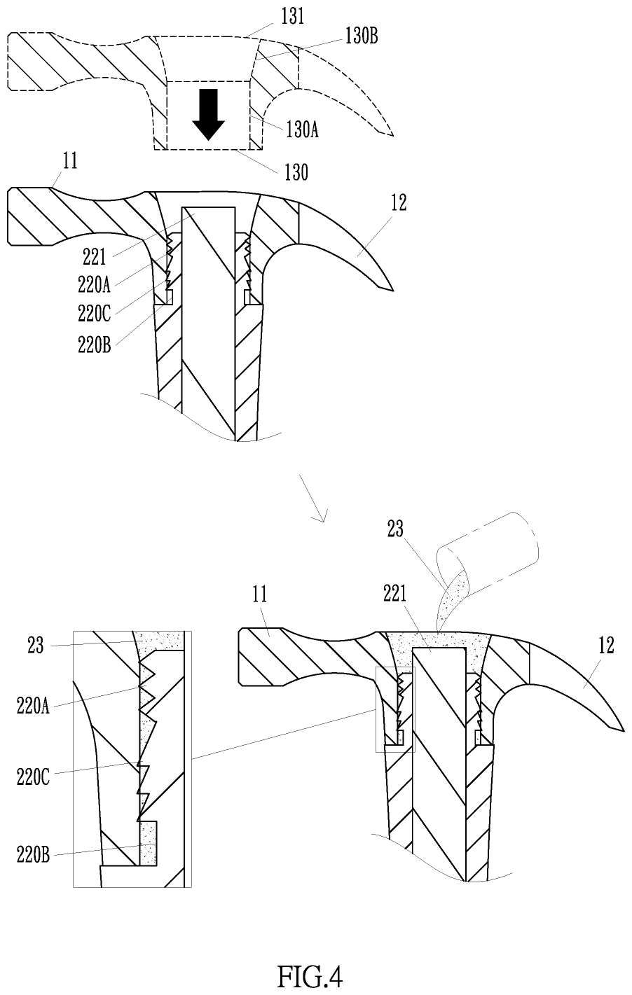

With reference to FIGS. 2 to 4 for the three-dimensional exploded view and its partial blowup state and the cross-sectional side view and its partial blowup state of an anti-overflow hammer and handle fixing structure, and the cross-sectional side view showing the assembly and the operation of filling an adhesive in accordance with the present invention respectively, the flared slot 13 of the hammer body 10 is sheathed on the fitting fixed head 22 of the handle body 20, the first fit section 130A and second fit section 130B of the flared slot 13 relative to the first fit portion 220 and second fit portion 221 of the fitting fixed head 22 respectively, and the serrated block 220A of the first fit portion 220 of the fitting fixed head 22 abuts against an inner wall of the first fit section 130A inner wall. With the first fit section 130A and second fit section 130B of the flared slot 13 of the hammer body 10 being abutted and latched by the first fit portion 220 and the second fit portion 221 of the fitting fixed head 22 of handle body 20 respectively to improve the combining stability, and the adhesive 23 is filled into the second opening 131 formed on the top side of the flared slot 13, so that the adhesive 23 can be filled up in the internal space of the second opening 131 of the flared slot 13 and permeated into the gaps of the first fit section 130A and the second fit section 130B relative to the first fit portion 220 and the second fit portion 221, and the residue of extra adhesive 23 is guided to the positions of the tooth gaps of the serrated block 220A of the first fit portion 220, the spaced helical serrated section 220C, the concave section 220B and the adhesive receiving notch 221A of the second fit portion 221, so that the adhesive 23 can be used to adhere and fix the hammer body 10 with the handle body 20 and prevent the overflow of any extra adhesive residue after the hammer body 10 and the handle body 20 are combined with each other, so as to improve the assembly convenience and stability and achieve high structural stability and assembly convenience.

With reference to FIG. 2 for the schematic exploded view and its partial blowup state of the anti-overflow hammer and handle fixing structure in accordance with the present invention, a top side of the first fit portion 220 of the fitting fixed head 22 of the handle body 20 has a threaded fixing groove 220D, and the second fit portion 221 is substantially in a cube-like strip shape, and the cube-like strip shaped second fit portion 221 is latched and accommodated in the threaded fixing groove 220D of the first fit portion 220, and thus the structure and assembly are simple and easy, and the combining stability is good, and the multiple practicality of the present invention is improved.

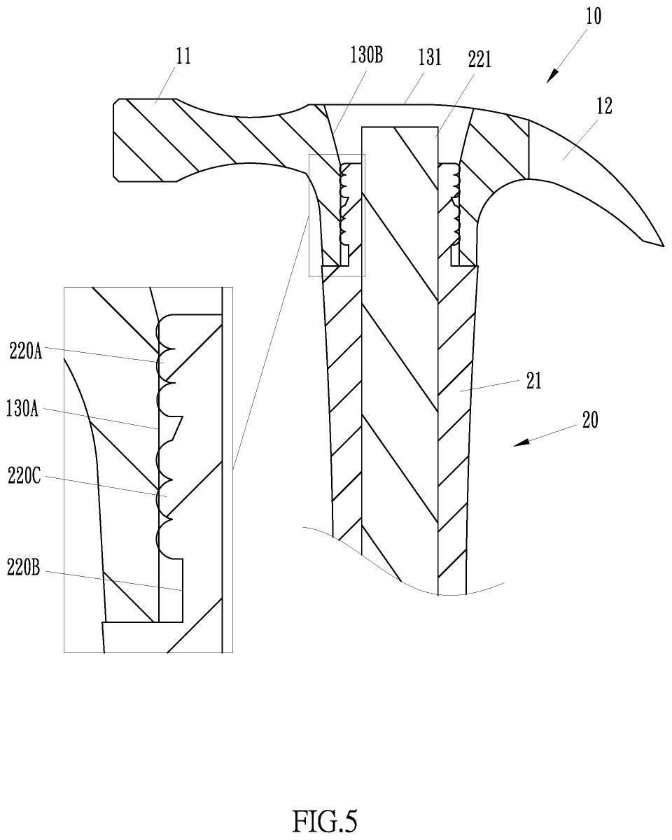

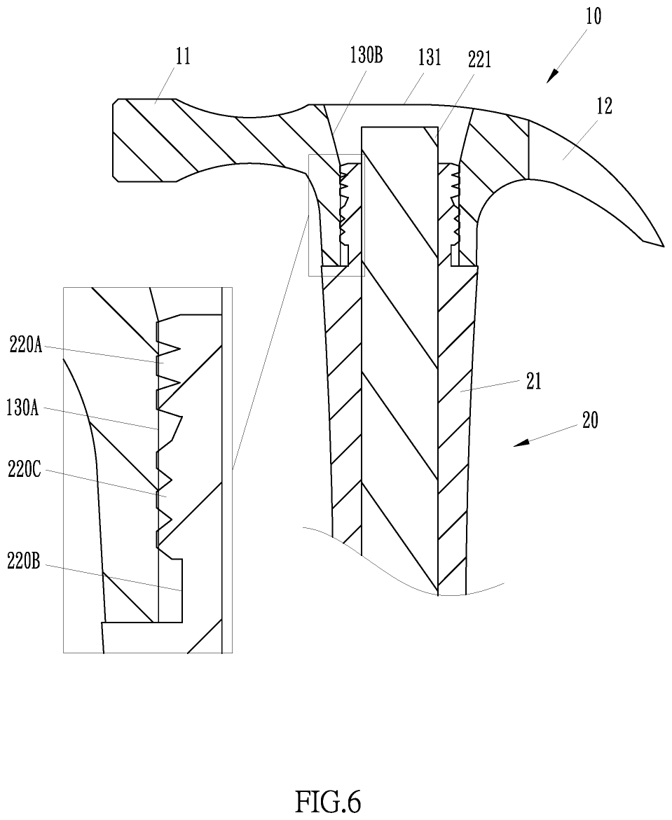

With reference to FIGS. 2, 5 and 6 for the exploded views and their partial blowup state of the anti-overflow hammer and handle fixing structure in accordance with the first and second embodiments of the present invention, wherein the spaced helical serrated section and the serrated block of the first fit portion of the fitting fixed head of the handle body of the first embodiment have a plurality of teeth, each being in the shape of a round angle, and the spaced helical serrated section and the serrated block of the first fit portion of the fitting fixed head of the handle body of the first embodiment have a plurality of teeth, each being in the shape of a trapezium angle, and the spaced helical serrated section 220C and the serrated block 220A of the first fit portion 220 have a plurality of teeth, each being in the shape of an acute angle, a round angle or a trapezium angle, so that the spaced helical serrated section 220C and the serrated block 220A relative to the first fit section 130A can be in a point, line, or surface contact, so as to improve the variability of the structural use of the present invention.

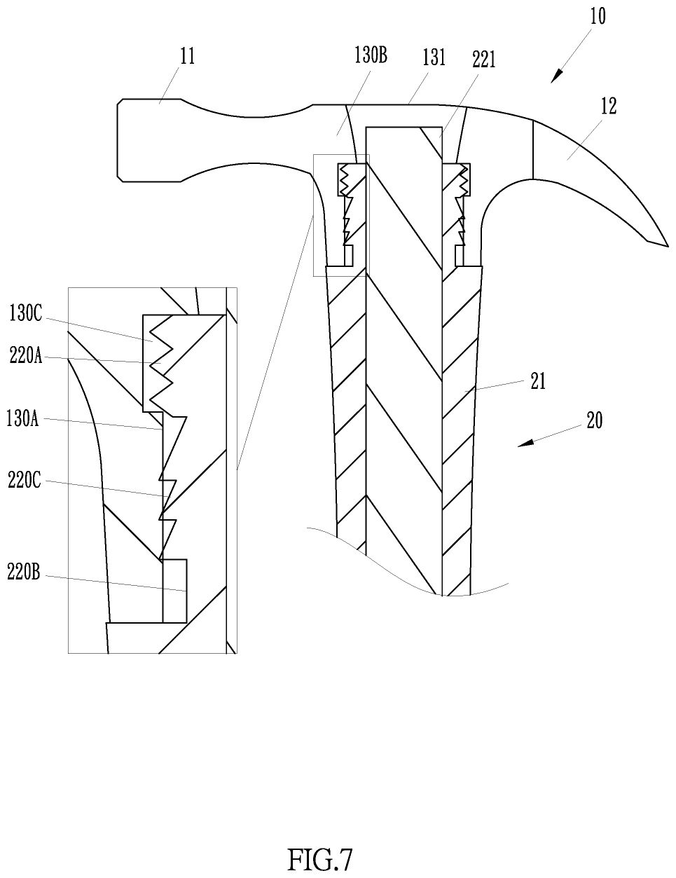

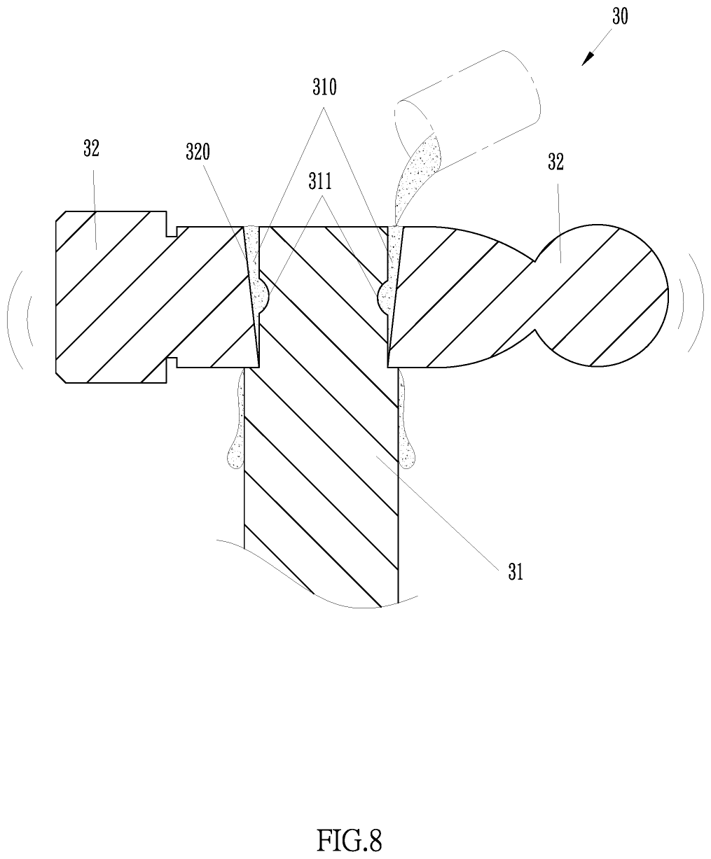

With reference to FIG. 7 for an anti-overflow hammer and handle fixing structure in accordance with the third embodiment of the present invention, this figure shows that both sides of the flared slot first fit section of the groove line of the hammer body are latched with the serrated block of the first fit portion of the fitting fixed head of the handle body, the overall structure is similar to those as shown in FIGS. 1 to 6, except that both sides of the first fit section 130A of the flared slot 13 of the hammer body 10 in accordance with the third embodiment further have two positioning latch grooves 130C, and the serrated block 220A of the first fit portion 220 of the fitting fixed head 22 is positioned and latched to the positioning latch groove 130C, to improve the variability of the structure use of the present invention.

In summation of the description above, the present invention surely can achieve the aforementioned functions and objectives, and complies with the patent application requirements, and thus is duly filed for patent application.

While the invention is described in some detail hereinbelow with reference to certain illustrated embodiments, it is to be understood that there is no intent to limit it to those embodiments. On the contrary, the aim is to cover all modifications, alternatives and equivalents falling within the spirit and scope of the invention as defined by the appended claims.

What is claimed is:

1. An anti-overflow hammer and handle fixing structure, comprising: a hammer body, having a hammer part and a claw part disposed on both sides of the hammer body respectively, a flared slot formed on the hammer body and penetrating from a bottom side to a top side of the hammer body and having a first opening and a second opening, and the first opening having a first fit section extending inwardly, and a second fit section relative to the first fit section and the opposite side of the first opening extending to the second opening; and a handle body, having a handle part and a fitting fixed head, and the fitting fixed head having a first fit portion and a second fit portion, and the second fit portion protruding from the top of the first fit portion, and the top side of the first fit portion relative to both sides of the second fit portion having a serrated block, and the first fit portion having a concave section and a spaced helical serrated section, and a plurality of adhesive receiving notches being spaced from one another and formed at the edges on both sides of the second fit portion respectively, and the flared slot of the hammer body being sheathed on the fitting fixed head, and the first fit section and the second fit section of the flared slot being configured to be relative to the first fit portion and the second fit portion of the fitting fixed head respectively, and the serrated block of the first fit portion of the fitting fixed head abutting against an inner wall of the first fit section.

2. The anti-overflow hammer and handle fixing structure as claimed in claim 1, wherein the first fit section of the flared slot of the hammer body has an inner peripheral wall substantially in a planar configuration, and the second fit section has an inner peripheral wall substantially in a slope configuration.

3. The anti-overflow hammer and handle fixing structure as claimed in claim 1, wherein the first opening of the flared slot of the hammer body has an opening width A smaller than the opening width B of the second opening.

4. The anti-overflow hammer and handle fixing structure as claimed in claim 1, wherein the concave section of the first fit portion of the fitting fixed head of the handle body has a width C smaller than the width D of the helical serrated end portion width D of the spaced helical serrated section to form an adhesive receiving space.

5. The anti-overflow hammer and handle fixing structure as claimed in claim 1, wherein the handle part of the handle body has a middle section and an upper section substantially in a concave arc configuration, and a lower section substantially in a convex arc configuration.

6. The anti-overflow hammer and handle fixing structure as claimed in claim 1, wherein the handle part of the handle body has an anti-slip shock absorber sheathed on an outer side thereof, and the anti-slip shock absorber has a first-section sleeve area and a second-section sleeve area, and a front side of the second-section sleeve area has an anti-slip grip section, and the anti-slip grip section has a plurality of groove lines spaced with one another.

7. The anti-overflow hammer and handle fixing structure as claimed in claim 1, wherein the fitting fixed head of the handle body has a threaded fixing groove formed at the top side of the first fit portion, and the second fit portion is substantially in a cube-like strip shape, and the cube-like strip shaped second fit portion is passed and accommodated into the threaded fixing groove of the first fit portion.

8. The anti-overflow hammer and handle fixing structure as claimed in claim 1, wherein the spaced helical serrated section and the serrated block of the first fit portion have a plurality of teeth, each in the shape of an acute angle, a round angle or a trapezium angle, so that the spaced helical serrated section and the serrated block are in a point, line or surface contact with the first fit section.

9. The anti-overflow hammer and handle fixing structure as claimed in claim 1, wherein both sides of the first fit section of the flared slot of the hammer body have two positioning latch grooves formed thereon respectively, and the serrated block of the first fit portion of the fitting fixed head is positioned and latched to the positioning latch groove.
